(19) United States
(12) Patent Application Publication
(10) Pub. No.: US 2006/0061260 A1
(43) Pub. Date: Mar. 23, 2006

(54) Method for changing a conversion property of a spectrum conversion layer for a light emitting device

(76) Inventors: Karl Leo, Dresden (DE); Jan Blochwitz-Nimotz, Dresden (DE); Joerg Amelung, Dresden (DE); Hartmut Froeb, Reinhardtsgrimma (DE); Martin Pfeiffer, Dresden (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/222,131

(22) Filed: Sep. 8, 2005

Related U.S. Application Data
(63) Continuation of application No. PCT/EP04/02848, filed on Mar. 18, 2004.

(30) Foreign Application Priority Data
Mar. 21, 2003 (DE) 10312679.1

(51) Int. Cl. H05B 33/00; H05B 33/02

(52) U.S. Cl. 313/501; 313/503; 313/506

(57) ABSTRACT

It is the knowledge of the present invention that the spectrum of any light emitting device can be converted into a desired spectrum in a simple way, by providing a light emitting device with a light conversion layer, which has a dye with a conversion property, to convert the light emitted by the light emitting device into light of a different spectrum, and thereupon acting upon the spectrum conversion layer such that the dye is at least partly removed or a conversion property is destroyed. In this way, it is also possible in a simple way to structure a display of a plurality of light emitting devices to a color display, by providing a spectrum conversion layer for all light emitting devices, i.e. for converting the light emitted by the light emitting devices into light of different spectra, and to then act upon these common spectrum conversion layers in selectively chosen locations, which correspond predetermined ones of the light emitting devices, such that at these locations the dye is at least partly removed or its conversion property is destroyed, so that at these locations light, which has not been converted or only less converted, is radiated from the display.

### CROSS-REFERENCE TO RELATED APPLICATION

This application is a continuation of copending International Application No. PCT/EP2004/002848, filed Mar. 18, 2004, which designated the United States and was not published in English, and is incorporated herein by reference in its entirety.

### BACKGROUND OF THE INVENTION

1. Field of the Invention

The present invention relates to light emitting devices and in a particular embodiment also to organic light emitting diodes, short OLEDs, and particularly to such light emitting devices, which have a spectrum conversion layer for spectrum conversion, to convert the emission spectrum of a light emitting area of the light emitting device into another spectrum.

2. Description of Related Art

Organic light emitting diodes emit via a layer of an organic material, which emits light of a certain emission spectrum when applying a voltage across the same. Therefore, organic light emitting diodes comprise generally a layer of an organic material with the above properties, for which the term OLED material will be used in the following, an electrode structure of two electrodes facing one another across the organic layer for applying a voltage across the organic layer and, if required, a substrate where this layer sequence is disposed.

Among the organic light emitting diodes, so-called substrate emitters are distinguished from top emitters. Organic light emitting diodes of the substrate emitter type emit the light from the organic layer through the substrate, while top emitters are provided to emit their effectively acting light in the direction away from the substrate. Further, organic light emitting diodes can be distinguished according to the type of the state of aggregation of the organic materials, wherein the organic material is prior to the deposition of the organic layer, namely in evaporated form or liquid form.

Which emission spectrum and which color, respectively, an organic light emitting diode emits depends first on the type of the organic material. Applying the voltage across the organic layer generates an electric field, which again causes an excitation of atoms in the organic material and finally effects a migration of electrons and holes opposite to one another. When electrons and holes meet, a recombination is effected, wherein depending on the condition of the organic material, different amounts of energy are released in the form of light. Since the selection of organic materials is limited, there are organic light emitting diodes which have a light conversion layer in addition to the organic light emitting layer, which either has filter properties to filter the emission spectrum of the organic layer in certain areas by absorption, or fluorescent or phosphorescent properties, according to which the light emitted by the organic layer is absorbed in the light conversion layer and after the transition from an excited into another energetic state, light is emitted again with another emission spectrum.

Lately, displays based on organic light emitting diodes have developed into an interesting alternative for the realization of flat displays. Therefore, contact layers and organic layers are disposed on an appropriate substrate such that several picture elements and pixels, respectively, are represented by electroluminescence. Compared to known concepts, such as based on liquid crystals, OLED displays have many advantages. Among them are the low power consumption, the very high angle of view and the high contrast. For realizing a full color display, it is normally necessary to be able to represent three primary colors with different intensity. These primary colors, such as red, green and blue, have to be generated by an appropriate structuring of one of the organic layers.

There are different possibilities for generating the different colors for every single picture element. It is one possibility to realize three spatially separated light emitting diodes, which correspond to three adjacent pixels, which emit respectively in a different one of three primary colors and which can be controlled separately to be able to adjust their light intensity separately. These light emitting diodes can be disposed laterally next to each other or alternatively also above one another in layer stack direction.

Another possibility for generating the different colors for every individual picture element and every individual pixel, respectively, is that the light emitting diodes of all pixels originally emit light of one and the same color, such as blue light, and this light will then be converted to both other colors by appropriate converter layers. These converter layers can, for example, be organic dyes, which fluoresce, i.e. absorb incoming photons and emit thereupon light of a different wavelength, or they can also be inorganic materials, which emit light after optical excitation. The organic or inorganic emitters can be deposited as massive layer or diluted and dispersed, respectively, in a polymer or in an inorganic or organic layer.

Another possibility is to realize a white emitting organic light emitting diode for every pixel and to generate the individual colors by filters, which each remove one part of the spectrum.

In all mentioned solutions it is obvious that for generating the different colors per picture element a structuring has to take place of either the light emitting or the light converting layer, namely the converter or the filter layer. Therefore, different possibilities exist. On the one hand, it is possible to distribute the light emitting diodes emitting in different colors only locally on the substrate. In the case of dyes dissolved in a polymer, the deposition of the polymer can be performed as solution by printing techniques, such as the inkjet printing technique. In light emitting diodes, which are made by vapor depositing from so-called small molecules, the structuring can, for example, be performed by shadow masks, which enable a deposition of a certain organic dye only on certain areas and pixel areas, respectively.

The above mentioned possibilities for structuring do, however, have significant disadvantages. The printing technique has, for example, the disadvantage that the light emitting polymers have to be brought into printable forms, which can decrease the efficiency. In the vapor deposited systems, the usage of the shadow mask has the disadvantage that the shadow mask has the tendency to clog with the evaporated organic material during evaporation, and therefore it has to be cleaned frequently. Above that, the organic material is expensive. On the other hand, shadow masks, in particular for bigger displays, tend to outshape, which affects the accuracy of the structuring.

It would therefore be desirable to have a more effective structuring technique.

### SUMMARY OF THE INVENTION

It is an object of the present invention to provide a more effective method for adjusting the spectrum of a light emitting device and a light emitting device, which can be produced more effectively, respectively, so that therefrom a more effective production of displays from these materials is made possible.

In accordance with a first aspect, the present invention provides a method for changing a transformation property of a spectrum conversion layer for a light emitting device, which emits light with an emission spectrum, wherein the spectrum conversion layer has a dye, which has a transformation property to convert light with the emission spectrum into light of a different spectrum, the method comprising the step of acting upon the spectrum conversion layer, such that the dye is at least partly removed or its transformation property destroyed.

In accordance with a second aspect, the present invention provides a method for manufacturing a color display starting from a regular arrangement of light emitting devices, each of which corresponding to a pixel in a pixel area of the color display and having an emission spectrum, and an overlaying arrangement of a first spectrum conversion layer and a second spectrum conversion layer arranged between the first spectrum conversion layer and the arrangement of light emitting devices, having the steps of changing a transformation property of the first spectrum conversion layer according to the above mentioned method; and changing a transformation property of the second spectrum conversion layer according to the above mentioned method.

It is the knowledge of the present invention that the spectrum of any light emitting device can be converted into a desired spectrum in a simple way, by providing a light emitting device with a light conversion layer, which has a dye with a conversion property or characteristic to convert the light emitted by the light emitting device into light of different spectra, and thereupon the spectrum conversion layer is acted upon such that the dye is at least partly removed or a conversion or transformation property is destroyed. In that way, it is also possible to structure a display of a plurality of light emitting devices to a color display in a simple way, by providing a spectrum conversion layer for all light emitting devices, i.e. for converting the light emitted by the light emitting devices into light of different spectra, and then this common spectrum conversion layer is acted upon at selectively chosen positions, which correspond to predetermined ones of the light emitting devices, such that the dye is at least partly removed at these locations or its conversion property is destroyed, so that at these locations, no or less converted light is emitted from the display.

According to a preferred embodiment of the present invention, the effect on the spectrum conversion layer is performed by irradiation of the same with light, such as by directing a laser beam on the desired location of the light conversion layer. In the case where the spectrum conversion layer is a layer of merely the dye, the wavelength of the light with which the spectrum conversion layer is radiated is chosen, for example, such that it corresponds to an absorption band of the dye, so that at this location, depending on intensity, the dye is either removed, ablated or changed such that it loses its conversion property. In the case that the spectrum conversion layer consists of a solid state solution of the dye and the matrix material, wherein the dye is included, the wavelength of the light, with which the spectrum conversion layer is radiated, can either be adjusted on an absorption band of the matrix material or an absorption band of the included dye, so that at least the dye loses its conversion property.

### BRIEF DESCRIPTION OF THE DRAWINGS

Preferred embodiments of the present invention will be discussed below in more detail with reference to the accompanying drawings. They show:

FIG. 1 a cross section partial view of an OLED with a converter layer according to the embodiment of the present invention;

FIG. 2 the absorption and fluorescence or phosphorescence emission spectrum of three different converter materials according to an embodiment of the present invention;

FIG. 3a, three different methods which make it possible to b and c generate light of three different colors from a light emitting device provided with one or two converter layers according to an embodiment of the present invention; and

FIG. 4a two methods, which make it possible to generate and b light of three different colors from a light emitting device provided with three filter layers according to a further embodiment of the present invention.

### DESCRIPTION OF THE PREFERRED EMBODIMENTS

Before the present invention will be discussed in more detail with reference to the embodiments and with reference to the following drawings, it should be noted that the same elements in the figures are provided with the same reference numbers, and that a repeated description of these elements is omitted.

Further, it should be noted that the following description relates mainly to changing the spectrum of organic light emitting diodes, but that the present invention can further be applied to other light emitting devices, such as semiconductor lasers, normal LEDs or the like.

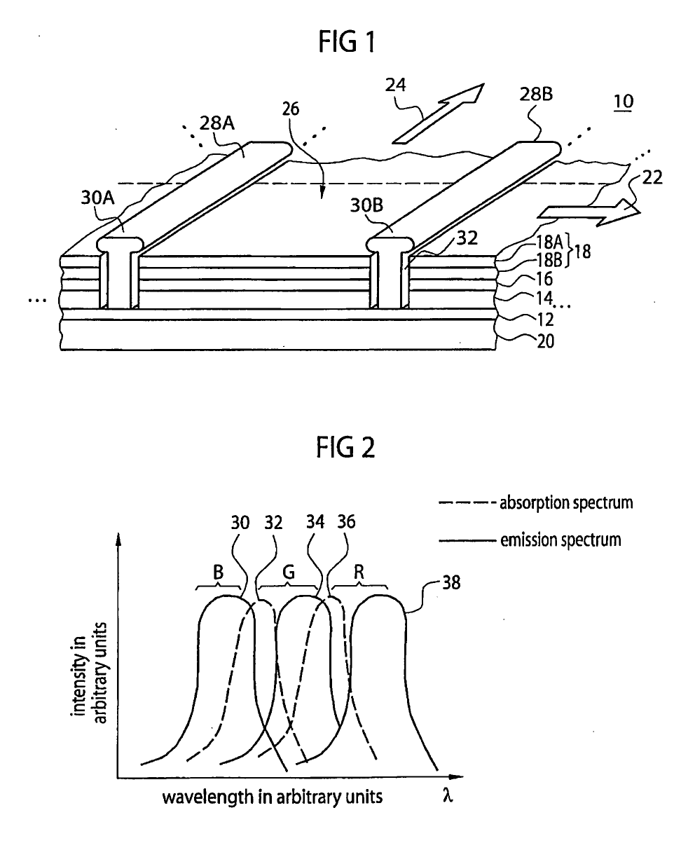

FIG. 1 shows a partial spatial sectional view of an OLED display with passive matrix control. The OLED display, generally indicated by 10, consists mainly of a layer arrangement of a lower cathode layer 12, a layer 14 of organic material, which has the property to emit light of a certain color and light of a certain emission spectrum, respectively, when applying a voltage across the organic material, in the following sometimes referred to shortly as OLED material, an upper transparent anode layer 16 and a converter layer 18, which are deposited on the substrate 20 in this order. The OLED display 10 consists of a plurality of OLEDs, which are disposed and distributed, respectively, in an arrangement of rows and columns on the substrate 20. Every OLED corresponds to a pixel of the display 10 and takes up a lateral pixel area. In FIG. 1, merely one OLED and pixel area, respectively, is fully visible.

The regular arrangement of the OLEDs of the display 10 in row direction 22 and column direction 24 and the individual controllability of every OLED is ensured by the structuring of the bottom cathode layer 12 and the upper anode layer 16. Particularly, the lower cathode layer 12 is structured in row traces running in row direction 22 and isolated from one another, while the upper anode layer 16 is structured in column traces running perpendicular thereto in the column direction 24 and isolated from one another. By applying a voltage between a predetermined row trace and a column trace, every area of the display 10 can therefore be controlled selectively to apply a predetermined voltage across the light emitting organic layer 14, which then emits light of an emission spectrum in this area, which depends on the respective organic material of layer 14. Each of these individually controllable areas represents therefore a pixel area and an individually controllable OLED, respectively, one of which is fully depicted in FIG. 1 in an exemplary way and generally indicated with 26.

When producing the display 10 of FIG. 1, first, the lower cathode layer 12 is deposited on the substrate and structured into the row traces. Thereupon, separators 28a, 28b are deposited on the lower contact layer 12, which are directed perpendicularly, namely in column direction 24, so that a column of pixel areas is respectively defined between adjacent separators 28a, 28b, which are divided into individual pixel areas by the row traces of the lower cathode layer 12. Then, layers 14, 16 and 18 are vapor deposited successively two-dimensionally on the full area. The separators 28a and 28b have a mushroom shaped cross section, wherein they are attached with a narrower edge end at layer 12, to project with a widened end 30a and 30b, respectively, pointing away from layer 12 and substrate 20. In this way, shadowings result by laterally projecting parts of the end 30a and 30b when vapor depositing the layers 14, 16 and 18, so that after their vapor deposition the same are structured automatically in columns isolated from one another, which are separated by gaps, which the separators 28a and 28b extend with a certain distance 32 to the inner walls of the gaps.

The converter layer 18 is disposed in two sublayers 18a and 18b disposed on top of one another. The anode layer 16 consists of a transparent material, which is transparent to light, which the organic material of layer 14 emits when applying a voltage. In the present embodiment, the organic material of layer 14 emits blue light when applying a voltage. The converter sublayer 18b has the property to absorb the blue light of layer 14 and to emit thereupon light in the green spectral range. The converter sublayer 18a, however, between which and layer 14 the converter sublayer 18b is disposed, has the property to absorb light in the green spectral range of the converter layer 18b and to emit thereupon light in the red spectral range.

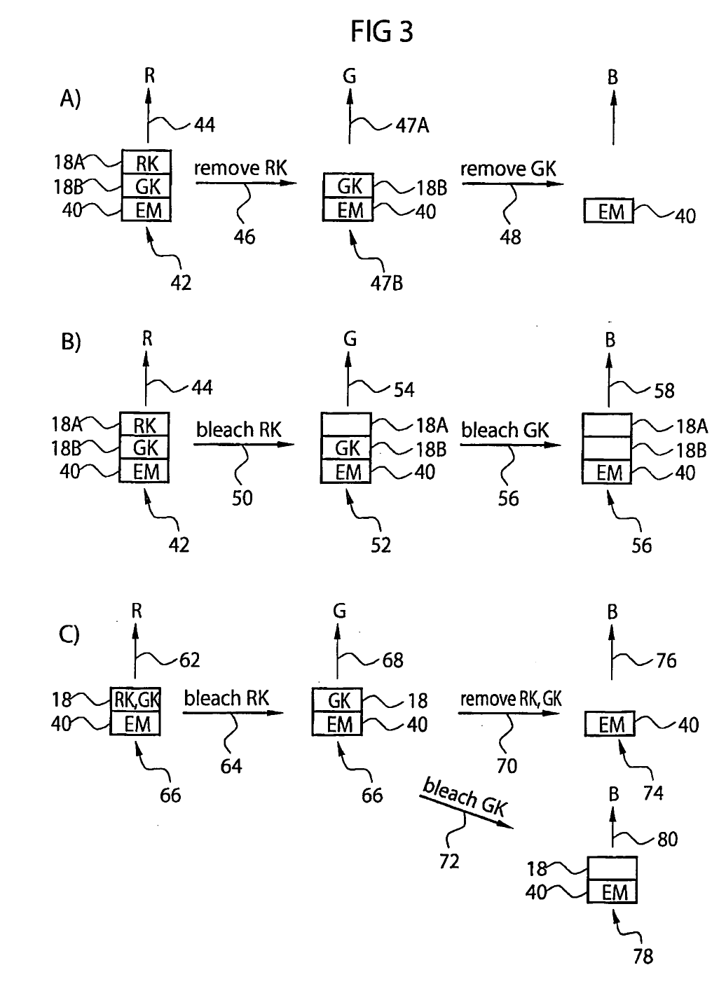

FIG. 2 shows the emission and absorption spectra of the layer 14 and the converter layers 18a and 18b, respectively, for the embodiment of FIG. 1. Particularly, FIG. 2 shows a graph where the wavelength is plotted along the x axis and the intensity of emission and absorption, respectively, along the y axis in arbitrary units. Braces indicate in which spectral range approximately the light lies, which is perceived as blue (B), green (G) and red (R) by the eye. The emission spectrum of the OLED layer 14 is indicated with 30, the absorption spectrum of the converter sublayer 18b with 32, the emission spectrum of the converter sublayer 18b resulting by the absorption of blue light with 34, the absorption spectrum of the upper converter sublayer 18a with 36 and the emission spectrum of the upper converter sublayer 18a resulting from the absorption of green light with 38, wherein absorption spectra are indicated with dotted lines and emission spectra with continuous lines.

After having described the structure of display 10, in the following, its behavior will be described with reference to the example of the OLED 26, which means a pixel of the same, when the respective OLED is activated. When applying a voltage between an appropriate row trace and an appropriate column trace, the voltage falling across the layer 14 effects that the organic material of layer 14, i.e. the OLED material emits light in the blue spectral range due to a recombination of electron/hole pairs. The layer 14 consists, for example, of several layers, which have an electron transport function, hole transport function and/or emitter function. The light emitted by one or several organic layers 14 passes the transparent anode layer 16 and reaches the converter sublayer 18b. There, the photons of the blue light of the OLED layer 14 are converted into light of a different emission spectrum. As can be seen from FIG. 2, a dye present in the converter sublayer 18b absorbs the blue light of the layer 14, which has the spectrum 30, as far as it overlaps the absorption spectrum 32 and emits thereupon green light with the emission spectrum 34.

The green light emitted by the converter sublayer 18b and the dye therein, respectively, is absorbed by a dye present in the converter sublayer 18a, as far as the emission spectrum 34 overlaps the absorption spectrum 36, whereupon the dye in the converter sublayer 18a emits red light with the emission spectrum 38. The direction into which the dye in the converter sublayer 18a emits light is directed in all directions, so that the fluorescent radiation does not only take place along the normal to the surfaces, but also in a large spatial angle portion thereto.

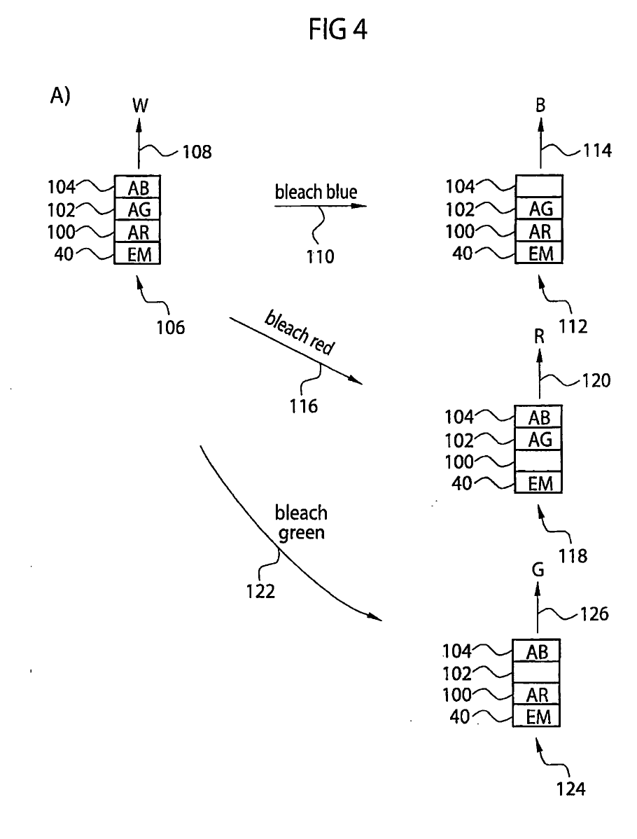

The state described up to now, wherein the display 10 is, represents an original state for producing a color display and enables it merely that all OLEDs of the display 10 emit red light with variable intensity. Therefore, to obtain a color display, the converter sublayers 18a and 18b have to be selectively subjected to an appropriate treatment at predetermined pixel areas, to selectively reduce their spectrum conversion properties and change them, respectively, such that apart from the pixel areas, where the converter layers remain unchanged and thus red light is emitted, pixel areas are formed, where green or blue light is emitted, as it will be described below with reference to FIGS. 3a-3c.

FIGS. 3a-3c show schematically three exemplary alternative methods, based on which a color display can be generated from the display 10 in its original state of FIG. 1 in a simple way. All three methods are based on the local effect on the converter sublayers and the converter sublayer, respectively, of display 10 of FIG. 1 and individual OLEDs of the same, respectively, via radiation with light of appropriate wavelength, such as by well-aimed directing of a laser beam of appropriate wavelength to a desired pixel area.

First, FIG. 3a shows a pixel area of display 10 of FIG. 1 in a state as shown in FIG. 1, namely with an unbroken converter layer 18a emitting red light (RK), a converter sublayer 18b emitting green light (GK), and the area of the OLED emitting blue light (EM), which is indicated with 40, and corresponds to layers 12, 14 and 16 on the substrate 20 in the case of the display 10, but could be any other area in the case of other light emitting devices. In this original state of FIG. 1, which is indicated with 42 in FIG. 3a, the pixel area emits red light, as it has been described above, as it is indicated by an arrow 44 and a capital R. Every pixel area of the display 10, as it is shown in FIG. 1, is in that state 42. The pixel area illustrated at 42 is thus merely a representative pixel area.

In order to be able to combine three adjacent pixel areas to one superpixel, which each combine light of a different primary color, two thirds of all pixel areas of the display of FIG. 1, namely two of each superpixel, are radiated in a step 46 as it is illustrated by an arrow 46 with a laser spot, such that the converter sublayer 18a is removed at these pixel areas. If this converter sublayer 18a is, for example, a layer consisting purely of the organic dye, the wavelength and the intensity of the laser beam directed to the respective pixel area are chosen in step 46 such that the wavelength of the laser beam lies in an absorption band of the organic dye in the converter sublayer 18a and the intensity is sufficient to remove the organic material. The wavelength is, for example, within the absorption band 36 (FIG. 2). An advantage is that neither the OLED material of the light emitting area 40 nor the dye in the converter sublayer 18b have an absorbing effect and have absorbing properties, respectively, in this spectral range. Thus, the sublayer 18a is removed at the desired locations and pixel areas, respectively, by the light influencing.

Consequently, after step 46, a third of all pixel areas of the display of FIG. 1 emit red light, since both their converter sublayers 18a, 18b are unchanged. Two thirds of all pixel areas emit green, as it is illustrated by an arrow 47a with G, since they are in a state where the upper converter sublayer 18a is removed, whereby the state in FIG. 3a is indicated with 47b.

Thereupon, half of the pixel areas, which emit green and are in a state 47b, are acted upon in step 48 by radiating with a laser beam such that the converter sublayer 18b is removed as well. In this step 48, assuming that the sublayer 18b is also a pure organic layer, the wavelength is adjusted such that it lies in an absorption band of the dye of the converter sublayer 18b, such as in the absorption band 32 of FIG. 2, where again advantageously no absorption band of the OLED material of the light emitting area 40 is present. After step 48, the color display is finished, since a third of all OLEDs is in the red emitting state 42, another third in the green emitting state 47b and another third in the state resulting from the step 48, since both converter sublayers 18a and 18b are removed and thus the blue light directly radiated from the area 40 exits unobstructed, as it is shown by an arrow 49a with B, wherein the latter state is indicated with 49b in FIG. 3a.

The methods according to FIG. 3a assume that the converter sublayers 18a, 18b are layers of pure dye and pure dyes, respectively. The method according to FIG. 3b assumes that the converter sublayers 18a, 18b are sublayers where the dye is embedded in a matrix material in the shape of a solid state solution, such as by simultaneous vapor depositing of the matrix material and the dye, such as titan dioxide or silica as matrix material and N,N′-Dimethylpenylen-3,4:9,10-bis-dicarboximide (BASF Paliogen®, L4120) as green yellow emitting, BASF Lumogen® F 083 as green emitting or BASF Lumogen® F 300 as red emitting dye (Lumogen F materials of BASF are perylenes or naphtalimids based on organic materials), wherein in this case the proportion of the organic dye is preferably less than 5 percent by volume. Other examples for conversion materials are coumarin dyes, cayanine based dyes, pyridine based dyes, xanthene based dyes (rhodamine B) or the like. Such a solid state solution could be generated, for example, by simultaneous vapor deposition of the organic dye and the matrix material in an overlapping vapor deposition zone.

FIG. 3b shows at 42 the same original state of an exemplary pixel area as FIG. 3a, namely with both converter sublayers 18a and 18b in intact form, wherein every pixel area of the display is in this original state. The only difference to the state 42 of FIG. 3a is the above-mentioned different structure of layers 18a and 18b. Starting from this original state, in a step 50, two thirds of all pixel areas are acted upon by radiation with laser light on the upper converter sublayer 18a, such that the dye embedded in the matrix material of the upper converter sublayer 18a is destroyed and converted, respectively, such that it loses its property to absorb light in the absorption band 36 and, thereupon, to emit light in the emission band 38, i.e. it loses its conversion property. Preferably, the matrix material should be transparent in the visible spectral range. This procedure will be referred to below as bleaching. The resulting state is shown in FIG. 3b at 52. In the state 52, the upper converter sublayer 18a is still present, wherein the dye embedded in its matrix material is destroyed, as it is indicated by the missing RK. As in step 46 of the procedure according to FIG. 3a, two thirds of all pixel areas of the display are treated in this way so that the pixel areas will subsequently emit green light, as it is illustrated by an arrow 54 with a capital G. In step 50, the wavelength is adjusted, for example, on an absorption band of the organic dye of layer 18a, such as the absorption band 36. Alternatively, the wavelength is adjusted to an absorption band of the matrix material.

After bleaching 50 the upper converter sublayer 18a, half of the pixel areas, which are in state 52, are acted upon once more with a laser beam, to convert and destroy, respectively, the dye in the lower converter sublayer 18b. In this step 56, the wavelength is chosen to lie in an absorption band of the dye in the converter sublayer 18b, such as the absorption band 32. The resulting state is indicated with 56 in FIG. 3b. In the state 56, the converter sublayers 18a and 18b are still present, but merely dyes, which have lost their conversion property, are embedded in its matrix material, as it is indicated in FIG. 2. In this way, merely the converter sublayers 18a and 18b transmit the light emitted by the light emitting area 40, so that these pixel areas, which are in state 56, emit blue. After step 50 and 56, consequently a third of all pixel areas emit red (state 42), a third of all pixel areas emit green (state 52) and a third of all pixel areas emit blue (state 56), as it is indicated by an arrow 58 and a capital B.

With reference to the description of FIG. 3b, it should be noted that it is further possible to set the wavelength of the radiated laser beam not to an absorption band of the dye to be converted and destroyed, respectively, but that it is further possible to set the wavelength to an absorption band of the matrix material of the respective converter sublayer. Thus, the matrix material of the converter sublayer 18a should, for example, be sufficiently transparent in the wavelength range of green and blue light, while the matrix material of the converter sublayer 18b should be transparent in the blue spectral area. Otherwise, the matrix materials can have absorption bands where the matrix material can be exited by the light radiation in steps 50 and 56 such that the dyes embedded therein are destroyed and converted, respectively.

The previous methods of FIG. 3a and 3b assumed that, as it is illustrated in FIG. 1, the converter layer is divided into two converter sublayers, which are disposed above one another and operate in a gradually effective manner. However, it is further possible to produce a converter layer, which consists of a matrix material and two dyes, which are embedded in the same matrix material, but have different conversion properties, such as the two previously described dyes, one of which, however, was provided in the converter sublayer 18a and the other one in the converter sublayer 18b. Thus, in FIG. 3c, a pixel area is illustrated exemplarily for all pixel areas in an original state 60, wherein the converter layer 18 is disposed above the light emitting area 40, wherein, as indicated by RK and GK, both a green emitting dye and a red emitting dye are embedded in a matrix material of the converter layer 18. The distribution of the two dyes in the matrix material of the converter layer 18 can hereby be varied in the thickness direction, in order to have, for example more green emitting dye in the area of the light emitting area and more red emitting dye in the area further away from the light emitting area.40. Further, the mixing ratio between matrix material, red emitting dye and green emitting dye can be appropriately set to any value according to a desired resulting primary color.

In the original state 60, wherein every pixel area is in the beginning, every pixel area emits red light, as indicated by an arrow 62 and an associated capital R. Thereupon, in a step 64, two thirds of all pixel areas are treated with laser light such that the red emitting dye (RK) is bleached, i.e. by setting the wavelength of the incident light beam lying in the absorption band of the red emitting converter. The state of the respective pixel areas resulting after step 64 is indicated with 66. Consequently, after step 64, a third of all pixel areas are intact and emit red (state 60), while two thirds of all pixel areas emit only green light, since merely the green emitting dye in the converter layer 18 has its conversion property, as it is indicated by an arrow 68 and an associated G.

Thereupon, half of all pixel areas, which are in the state 66, are further exposed to a laser beam, to fully remove the converter layer in these pixel areas, as indicated with arrow 70, or, as indicated at 72, to bleach also the green emitting dye in the converter layer 18. Thereupon, according to the alternative 70, a third of all pixel areas would be in a state 74, wherein no converter layer is disposed above the light emitting area 40 any longer, so that they will emit blue light, as indicated by an arrow 76 and a capital B. According to the alternative 72, the converter layer 18 would still be present in these pixel areas, but the dyes embedded in the matrix material of the same would both have lost their conversion property. The latter state is indicated at 78. In the state 78, these pixel areas emit also blue light, as it is indicated by an arrow 80 and a capital B, as it comes directly from the light emitting area 40.

With reference to the procedure according to FIG. 3c, it should be noted that it is not necessary to perform the steps 64 and 70 separately, to obtain the state 74 for a third of all pixel areas. Alternatively, for bleaching both the red emitting and the green emitting dye in the matrix material of the converter layer 18, it would further be possible to radiate these pixel areas with light, whose spectrum has both an absorption band of the green emitting dye and an absorption band of the red emitting dye. In these pixel areas it would further be possible to set the wavelength of the incident laser beam to a wavelength, which lies in the absorption band of the matrix material and to set the intensity of the incident light beam so high that the matrix material is fully removed together with the two dyes or only both dyes are fully destroyed. Above that, in the embodiment of FIG. 3c, the matrix material does not necessarily have to be present, which means the converter layer can be a mixture of, for example, blue green and green red converter 18a and 18b.

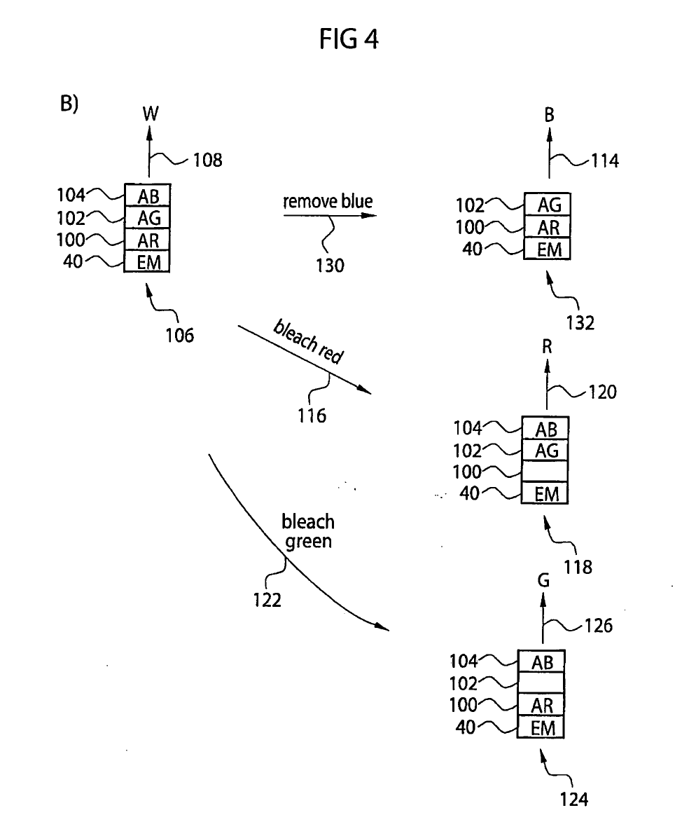

The above embodiments related to the processing of pixel areas and light emitting devices, respectively, where a converter layer has been manipulated appropriately to set a desired spectral range where the light emitting device emits light. In the following embodiment of FIG. 4, it is assumed that the pixel areas of the display, which is to be structured to a color display, are composed of a respective area emitting white light on the one hand as well as three filter layers on the other hand, wherein each of the three filter layers filters one of three primary colors and lets the others pass. FIGS. 4a and 4b show two procedures by which a color display can be obtained starting from a display where all pixel areas are prepared in that way.

FIG. 4a shows the original state of every pixel area. In this original state, a filter layer 100, which contains a dye absorbing in the red spectral range (AR), a filter layer 102, which contains a dye absorbing in the green spectral range (AG), and a filter layer 104, which contains a dye absorbing in the blue spectral range (AB), are disposed on the light emitting area 40 in this order, wherein this original state in which all pixel areas are at first, is indicated by 106. In FIG. 4a it is assumed that all filter layers 100-104 are such ones where the dye to be filtered is embedded in a matrix material. Basically, all filter dyes can be taken into consideration, which are disposed from a solution, such as Cl Reactive red 120 as red absorber, Cl Acid Blue 83 as blue absorber, Cl Acid yellow 42 as yellow absorber, Cl Direct Blue 86 as blue absorber or a mixture of Cl Acid Yellow 42 and Cl Direct Blue 86 as green absorber, or such ones, which are vapor deposited under a vacuum, such as perylene as red absorber, copper phthalocyanine as blue absorber or octaphenyle phthalocyanine as green absorber.

Both embodiments of FIG. 4a and FIG. 4b assume that the light emitting area 40 of every pixel area emits white light, which consists of the three primary colors red, green and blue.

In the original state 106, every pixel area spectrally emits broad, white or white-like light, as is indicated by arrow 108 with W beside it, since the white light of the light emitting area 40 is attenuated evenly by the filter layer 100 in the red spectral range, by the filter layer 102 in the green spectral range and by the filter layer 104 in the blue spectral range, and thus leaves the filter layers 100 to 104 as white light 108.

A third of all pixel areas are now treated in a step 110 by a laser beam, such that the absorbing dye in the filter layer 104 is bleached, by setting the wavelength of the incident light beam to an absorption band of the absorbing dye in the filter layer 104. In step 110, for example, blue laser light is used, for which the filter layers 102 and 100 are transparent and the dyes therein are not absorbing, respectively. The above illustrated principle with reference to converter layers can consequently be applied to filter layers as well, by selective radiation into the absorption bands of the filter dyes to remove and bleach them, respectively.

The state resulting after step 110 is indicated with 112. The state 112 differs from the original state 106 merely in that the absorbing dye in the filter layer 104 has lost its filter properties by bleaching 110. The light emitted by the light emitting area 40 is filtered consequently only by the filter layers 100 and 102 in the green and red wavelength range, and leaves the pixel area as blue light, as it is indicated by the arrow 114 and an associated capital B. In a respective way, in a step 116, a further third of all pixel areas is radiated with laser light of a wavelength which lies in the absorption band of the absorbing dye in the filter layer 100, for which, however, the filter layers 102 and 104 are transparent. The resulting state is indicated by 118. Pixel areas, which are in a state 118, emit red light, as it is indicated by an arrow 120 and a capital R, so that in the white light emitted by the light emitting area 40 merely the red part is no longer filtered out, since the red absorbing dye in the filter layer 100 has been destroyed by light influencing. Accordingly, in a step 122, it is made sure by light radiation at the other pixel areas that the absorbing dye in the filter layer 102 becomes destroyed, by setting the wavelength of the incident light beam to an absorption band of this dye. This is performed, for example, by setting the wavelength to the green spectral range. The resulting state is indicated by 124, wherein pixel areas in this state emit green light, as is indicated by an arrow 126 and a G. Consequently, after steps 110, 116 and 122, a third of all pixel areas emit blue light, another third red light and again another third green light. Three adjacent pixel areas of the states 112, 118 and 124 can be respectively combined to a superpixel and by controlling the intensity of the light emitting areas 40 of these pixel areas, any color impression can be generated in the eye of the viewer.

The procedure according to FIG. 4b differs from the one of FIG. 4a in that instead of merely destroying the absorbing dye of the upper filter layer 104 for a third of all pixel areas such that it loses its absorbing property in step 110, the whole layer is removed, wherein here, in difference to FIG. 4a, it is assumed that the upper filter layer 104 is a layer consisting purely of the absorbing dye. For those pixel areas, which are to emit blue, the upper filter layer is removed by radiation with a laser beam according to the procedure of FIG. 4b in a step 130, by setting the wavelength of the laser beam to a wavelength which lies in the absorption band of the absorbing dye in the filter layer 104. The resulting state for the respective pixel areas after step 130 is indicated by 132. As can be seen, in comparison to the original state 106, the upper filter layer 104 is missing, which means that these pixel areas, as it is indicated with an arrow 134 and a B, emit blue light, since blue is no longer filtered. For the other pixel areas, steps 116 and 122 are performed as described with reference to FIG. 4a.

The arrangement of the absorber layers 100, 102, 104 in FIGS. 4a,b can also be any other than illustrated in FIG. 4a,b.

With reference to FIGS. 3a-c and 4a, 4b it should be noted that a bleaching procedure is also possible with layers where the filter or converter dye is not in a matrix material in the form of a solid state solution, but further also in the case where the conversion layer consists of a pure dye. Conversely, with an appropriate choice of the matrix material, it is also possible to effect the removal in the case where the dye is in a matrix material.

With reference to FIG. 1-4 and particularly to FIG. 3 and 4, structuring techniques have been presented where structuring of the light emitting areas of the pixel areas of a display, as in the present case the organic light emitting diodes, can be avoided, and where structuring of the necessary converter and filter layers, respectively, can be realized very easily and without expensive structuring methods, such as photolithography. The procedure according to FIGS. 3a-c and FIGS. 4a, 4b makes it possible to produce a full color display from a single color display, where in the pixel areas blue emitters are combined with converter layers and white emitters with filter layers, respectively.

Although the embodiments have been described above, particularly with regard to FIG. 1, merely with regard to a passive matrix arrangement, where the individual control of the individual light emitting devices has been performed by conductive traces running in columns and rows, the present invention can further be applied to displays with active matrix arrangement where the individual light emitting devices and the light emitting diodes, respectively, can be made individually controllable by an active electronic circuit.

The above embodiments related to two-dimensional depositing a converter and absorber layer, respectively, on the full area of an array-like arrangement of light emitting areas, and to realizing the individual colors of the pixel areas by removing or destroying the converter and filter dye, respectively, locally by a light source and changing the converter and absorber elements, respectively. Instead of a laser any other appropriate light source can be used. Alternatively, however, the converter and absorber elements, respectively, could be acted upon in another way, such as by local heat treatment, X-ray radiation, ion radiation, ion bombardment, electron radiation or the like.

Further, it should be noted that the present invention can be further be applied to substrate emitters, where the substrate is transparent and the converter and filter layers, respectively, are disposed between substrate and the light emitting area. The structuring sequences according to FIGS. 3a-3c and 4a, 4b, respectively, would then be performed before the light emitting areas of the pixel areas as well as the associated control electrode structures would be disposed, or they could also be performed through the transparent substrate.

Further, it should be noted that it could be advantageous to provide and to apply, respectively, protective layers between light emitting area and conversion and filter layers, respectively, which avoid damaging of the light emitting areas when structuring and radiating with light, respectively. Such a protective layer could, for example, be a dielectric mirror, which in the case of using converter layers, which perform the light conversion by converting via fluorescence, only transmits the light of the light emitting area, in the case of FIG. 1 only blue light, and blocks and reflects, respectively, the light emitted by the converter layers and the converter layer, respectively, in the case of FIG. 1 red and green light. An absorbing effect of -the protective layer additional or alternative to the reflective effect, by which damaging of the light emitting area are removed, would also be possible.

Consequently, in the above-described manner, displays can be obtained based on organic light emitting diodes, where the different colors of picture elements are generated by converting the emission of the organic light emitting diodes and by absorption from a broad emission of organic light emitting diodes, respectively, and where these conversion and absorption layers, respectively, are structured locally by light influencing, namely by removal with light sources (e.g. FIG. 3a) or by light induced bleaching (e.g. FIG. 3b).

With regard to the above-mentioned precise color indications in the previous description, such as blue, red and green, it should be noted that the above embodiments can of course be varied, so that the light emitting area emits, for example, ultraviolet light instead of blue light or the like. With regard to the mentioned structure of the filter and converter layers, respectively, also many variations are possible, as has already been indicated in the previous description. Thus, for example, converter and absorption layers, respectively, of dyes in a polymeric matrix are possible, like converter and absorption layers, respectively, of dyes in an inorganic matrix, as has also been already described above. Further, the dyes of the converter layers can be inorganic materials, which absorb light of the light emitting area and emit at a different wavelength, or purely organic materials, as has also been described above. Further, it should be noted that converter and filter layers, respectively, can be combined to selectively remove the same by light radiation in an overlapping arrangement and to destroy the color and absorber dyes therein, respectively.

The above embodiments related mostly to monitors as specific form of displays, which are connected, for example, to a computer to mix pixels of different primary colors as colors. The present invention however, can also be advantageously applied to other applications, namely for example as OLED image displays disposed on paper as advertisement, which merely either show or not show one and the same image.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method for changing a transformation property of a spectrum conversion layer for a light emitting device, which emits light with an emission spectrum, wherein the spectrum conversion layer comprises a dye, which has a transformation property to convert light with the emission spectrum into light of a different spectrum, the method comprising the step of:
acting upon the spectrum conversion layer, such that the dye is at least partly removed or its transformation property destroyed.

2. The method according to claim 1, wherein in the step of acting upon, the acting upon takes place locally by means of selectively aiming a light beam, X-ray radiation, electron radiation or ion irradiation at the spectrum conversion layer.

3. The method according to claim 1, wherein the light emitting device is an organic light emitting diode with a layer with OLED material, which emits light with the emission spectrum when applying a voltage falling across the same.

4. The method according to claim 1, wherein the step of acting upon comprises radiating the spectrum conversion layer with light.

5. The method according to claim 4, wherein a wavelength of the light with which the spectrum conversion layer is radiated is chosen such that it corresponds to an absorption band of the dye.

6. The method according to claim 1, wherein the spectrum conversion layer is a layer of merely the dye.

7. The method according to claim 1, wherein an intensity of the light, with which the spectrum conversion layer is radiated, is at least sufficient to ablate the spectrum conversion layer.

8. The method according to claim 1, wherein the spectrum conversion layer consists of a solid state solution of the dye and a matrix material.

9. The method according to claim 8, wherein a wavelength of the light, with which the spectrum conversion layer is radiated, is set to an absorption band of the matrix material.

10. The method according to claim 1, wherein the dye is an organic dye.

11. The method according to claim 1, wherein the dye is made such that it absorbs light of at least a wavelength in the emission spectrum and in response thereto emits light with a different emission spectrum.

12. The method according to claim 1, wherein the dye is made such that it absorbs light of at least a wavelength in the emission spectrum.

13. The method according to claim 1, wherein a protective layer is provided between the spectrum conversion layer and the light emitting device, wherein the protective layer at least partly reflects and/or absorbs light, with which the spectrum conversion layer is radiated, but lets pass the light with the emission spectrum.

14. The method according to claim 1, wherein the step of acting upon takes place without photolithography.

15. A method for manufacturing a color display starting from a regular arrangement of light emitting devices, each of which corresponding to a pixel in a pixel area of the color display and comprising an emission spectrum, and an overlaying arrangement of a first spectrum conversion layer and a second spectrum conversion layer arranged between the first spectrum conversion layer and the arrangement of light emitting devices, comprising the steps of:
changing a transformation property of the first spectrum conversion layer by acting upon the first spectrum conversion layer, such that the dye is at least partly removed or its transformation property destroyed; and
changing a transformation property of the second spectrum conversion layer by acting upon the second spectrum conversion layer, such that the dye is at least partly removed or its transformation property destroyed.
